(19) United States
(12) Patent Application Publication
(10) Pub. No.: US 2015/0324372 A1
(43) Pub. Date: Nov. 12, 2015

(54) DEVICE MNEMONICS

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/274,165

(22) Filed: May 9, 2014

(51) Int. Cl. G06F 17/30

(52) U.S. Cl. CPC G06F 17/3087

(57) ABSTRACT

Apparatuses, methods and storage media associated with device mnemonics are disclosed herein. A registration module may be configured to accept a registration of a device mnemonic associated with a device, including receiving one or more communication addresses to be associated with the device mnemonic, and store the device mnemonic. A response module may be configured to respond to a query about the device mnemonic with at least the associated communication address(es). Acceptance of registration and storage of the device mnemonic may further comprise receipt of metadata to be associated with the device mnemonics. The response module may be configured to respond to a query about the device mnemonics, by providing some or all of the associated metadata. The registered/stored device mnemonics and their associated information may be queried and used by application services. Other embodiments may be described and/or claimed.

### TECHNICAL FIELD

The present disclosure relates to the field of data processing, in particular, to apparatuses, methods and storage medium associated with providing device mnemonics services.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of contents and/or information through the Internet. Today, users routinely use search services, such as Google®, Bing®, Yahoo®, and so forth, to locate information. Generally speaking, user searches or questions can be broadly classified as “what,” “when,” “how,” or “where” questions. For examples, “what are the movies being shown in a local cinema complex,” “when is kick off for a football game,” “how do you make pop corns in microwave,” or “where is the magnificent mile”? Today, search services would typically make no distinction between the different types of questions, and employ the same approach to providing answers to these questioning, by maintaining a collection of indices indexing the contents/information available on Internet. The indices are keyword-based, that is based on the presence of keywords in the content and/or the metadata associated with content, such as non-textual audio/video content. In response to a search query, the search service will utilize the keyword based indices or a subset thereof to generate and return an answer set with locators to potential relevant contents to the search query. Certain ranking and/or relevance analysis algorithm may be applied/used to filter and/or order the potential relevant contents/information included in the answer set.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for providing device mnemonics services, in accordance with various embodiments.

FIG. 2 illustrates an example organization of device mnemonics and their associated data, in accordance with various embodiments.

FIG. 3 illustrates an example process for providing device mnemonics services, in accordance with various embodiments.

FIG. 4 illustrates an example process for using the device mnemonics service by other online services, in accordance with various embodiments.

FIG. 5 illustrates an example organization of device mnemonics and associated data, in accordance with various embodiments.

FIG. 6 illustrates an example storage and access of device mnemonics and associated data, in accordance with various embodiments.

FIG. 7 illustrates an example computing environment suitable for practicing the disclosure, in accordance with various embodiments.

FIG. 8 illustrates an example storage medium with instructions configured to enable an apparatus to practice the processes of the present disclosure, in accordance with various embodiments.

### DETAILED DESCRIPTION

Apparatuses, methods and storage media associated with device mnemonics are disclosed herein. In embodiments, an apparatus may include a registration module and a response module. The registration module may be configured to accept a registration of a device mnemonic associated with a device and store the device mnemonic. For example, a device mnemonic “&ravis_car” may be associated with a car owned by a person named Ravi. Acceptance of registration and storage of the device mnemonic may further include receipt of one or more communication addresses to be associated with the device mnemonic, e.g., an email address such as “ravicar@example.com,” and/or an IP address, and storage of the communication address(es) as associated with the device mnemonic. The response module may be configured to respond to a query about the device mnemonic, with at least the associated communication address(es).

In embodiments, acceptance of registration and storage of the device mnemonic may further comprise receipt of metadata to be associated with the device mnemonics. For example, metadata may include a business associated with the device, a physical location of the device, and/or information about communication or processing capabilities of the device. The response module may be configured to respond to a query about the device mnemonics, further providing some or all of the associated metadata. The device mnemonic may be further associated with business metadata. Accordingly, user experience for locating information associated with a device or business may be enhanced. The information may, in turn, because to communicate with the registered device, or to communicate about the registered device. For example instructions may be sent to a device using a communication address associated with the device. In another example, if a device is associated with a business or personal entity, that business or personal entity may be communicated with or about using the device mnemonic.

In embodiments, the registered/stored device mnemonics and their associated information may be queried and used by application services, such as search engine, social networking services, message services, Internet portal services, e-commerce services or email services, to enhance the respective services provided.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

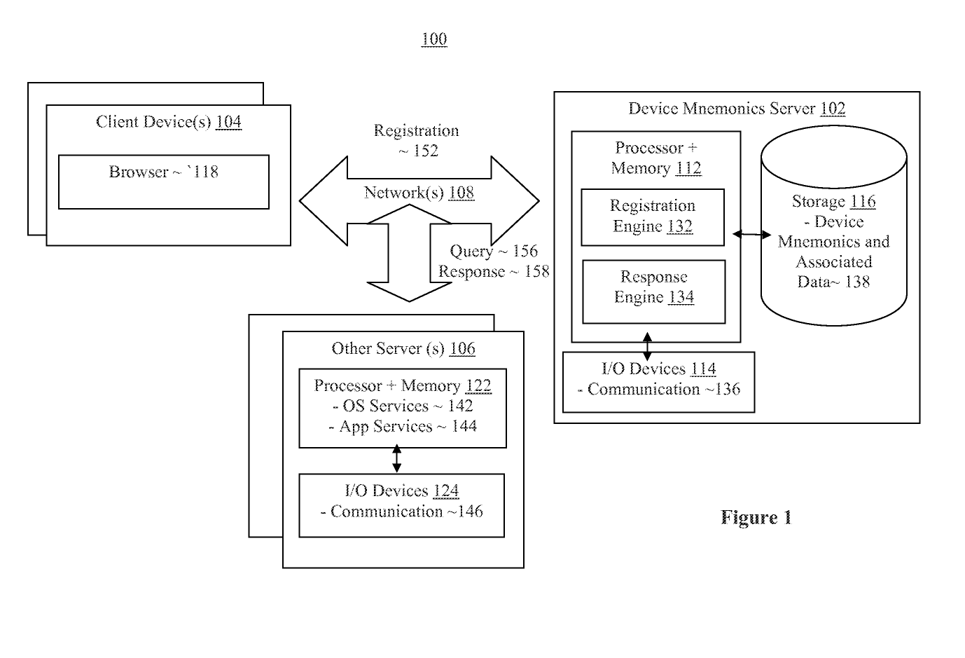

Referring now FIG. 1, wherein an arrangement for providing device mnemonics services is illustrated in accordance with various embodiments. As shown, in embodiments, arrangement 100 may include server 102 configured to offer device mnemonic services for client devices 104 and servers 106 of other online services. Device mnemonics server 102, client devices 104, and server 106 of other online services may be coupled to one another via network 108, as shown. In embodiments, server 102 may include processor and memory arrangement 112, input/output device 114, and storage 116, coupled with each other as shown. Processor and memory arrangement 112 may be configured to host registration engine 132, and response engine 134. In embodiments, registration engine 132 may be configured to accept registration of device mnemonics and their associated communication addresses from client devices 102, and store the registered device mnemonics and their associated communication addresses in storage 116 for subsequent provision to client devices 104 and/or servers 106 of other online services, in facilitating providing information associated with a location or an area. In embodiments, registration engine 132 may be further configured to accept metadata associated with the device mnemonics, from client devices 102, and store the associated metadata of the device mnemonics in storage 116 for subsequent provision to client devices 104 and/or servers 106 of other online services. Response engine 134 may be configured to provide the appropriate registered device mnemonics, associated addresses and/or met data, in response to subsequent query from client devices 104 and and/or servers 106 of other online services.

In embodiments, the format of a device mnemonic may be defined by the device mnemonic service. In embodiments, the device mnemonic service may define a device mnemonic to have the format of one or more special characters, followed by any number of alphanumeric and special characters. For example, the device mnemonic service may define a device mnemonic to have the format of having the special character “&” as the lead-off character, followed by one or more alphanumeric and special characters, such as “&Ravis_car,” or “&Ryans_server.” As another example, the device mnemonic service may define a device mnemonic to have the format of having the special characters “#&” as the lead-off characters, followed by one or more alphanumeric and special characters, such as “#&Ravi_car,” or “#&Ryans_server.” These examples are just illustrative, and not meant to be limiting on the present disclosure.

In embodiments, communication addresses stored and associated with the device mnemonic may include various addresses used by various communication protocols to communicate with a device for which a device mnemonic is registered. For example, the registration engine 132 may be configured to accept an email address to store in the storage 116 in association with a device mnemonic. In another example, an domain name, Uniform Resource Locator, Internet Protocol (“IP”) address, or other communication address may be registered with the registration engine 132. In embodiments, when the communication address does not include an IP address, in the course of storing device mnemonics, associated communication addresses and metadata 138 into storage 116, registration engine 132 may further resolve the provided communication address to an IP address for storage. Further, in embodiments, registration engine 132 may organize the storage of the device mnemonics, their associated addresses, and metadata, based at least in part on the communication addresses to facilitate subsequent processing and retrieval.

While for ease of understanding, registration engine 132 and response engine 134 are being illustrated as being operated by processors of processor and memory arrangement 112, in embodiments, registration engine 132 and response engine 134 may be implemented in any combination of hardware and/or software. In embodiments, the combination of hardware and/or software may include processor(s), memory and executable instructions implementing the functions described herein. In embodiments, in lieu of being two separate engines, registration engine 132 and response engine 134 may share some common functions and/or resources. For example, registration engine 132 and response engine 134 may share common communication functions and components for communicating with client devices 104 and servers 106 of other online services. As a further example, registration engine 132 and response engine 134 may share processor and/or memory resources. In embodiments, some functions of registration engine 132 and response engine 134, or vice versa, or be combined.

Processor and memory arrangement 112, in addition to registration engine 132 and response engine 134, may further host execution of various operating system (OS) services (not shown). The OS services may include any one of a number of OS services known in the art, including but not limited to memory management, task management, and so forth. I/O devices 114 may include one or more communication interfaces 128 configured to facilitate communication with client devices 104, and servers 106 of other online services. Communication interfaces 128 may be any one of a number of communication components/interfaces known in the art, including but not limited to, wired or wireless communication components for personal, local and/or wide area network communications. Storage 116 may be implemented using any magnetic, optical, and/or solid state non-volatile storage. The magnetic, optical, and/or solid state non-volatile storage may be disposed on one platform, or coupled/networked. In embodiments, storage 116 may also include volatile and/or non-volatile caches. Accordingly, except for the teachings of the present disclosure incorporated therein, server 102 is intended to represent a broad of single or multi-processor servers known in the art. In embodiments, server 102 may include one or more clusters computing servers, which may be coupled with one another, via one or more local or wide area networks (not shown).

Still referring to FIG. 1, client device 104 may include browser 118 configured to access the device mnemonics service offered by server 102, including interactions with registration engine 132 to register one or more device mnemonics, including their associated communication addresses and metadata, and/or interactions with response engine 134 to query and retrieve device mnemonics and/or associated data. Thus, client device 104, except for its usage and consumption of the device mnemonics service, represents a broad range of client devices known in the art, including but not limited to personal digital assistants (PDA), smartphones, computing tablets, ultrabook, laptop computers, desktop computers, set-top box, media players, game consoles, in-vehicle/portable navigation/infotainment systems, and so forth.

Similar to server 102, each of servers 106 may include processor and memory arrangement 122, and I/O devices 124 coupled to with each other as shown. Processor and memory arrangement 122 may host OS Services 142 and application services 144. While I/O devices 124 may include one or more communication interfaces 146. Similar to processor and memory arrangement 112, processor and memory arrangement 122 may be any one of a wide range of such elements known in the art. Likewise, similar to I/O devices 114 and communication interfaces 136, I/O devices 124 and communication interfaces 146 may be any one of a wide range of such elements known in the art. As described earlier, OS Services 142 may include a wide range of OS services, including but not limited to memory management, task management, and so forth. Application services 144, except for their usage of device mnemonics services, may likewise be any one of a number of online services known it art. Examples of such services may include, but are not limited to, online search services, social networking services, messaging services, Internet portal service, e-commerce service, and email service to be described in more detail below.

Networks 108 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the servers' end, networks 108 may include one or more local area networks with gateways and firewalls, through which servers 102 and 106 go through to communicate with client devices 104 and each other. Similarly, at the client device end, networks 108 may include base stations and/or access points, through which client devices 104 communicate with servers 102 and 106. In between the various ends may be any number of network routers, switches and other networking equipment of the like. However, for ease of understanding, these gateways, firewalls, routers, switches, base stations, access points and the like are not shown.

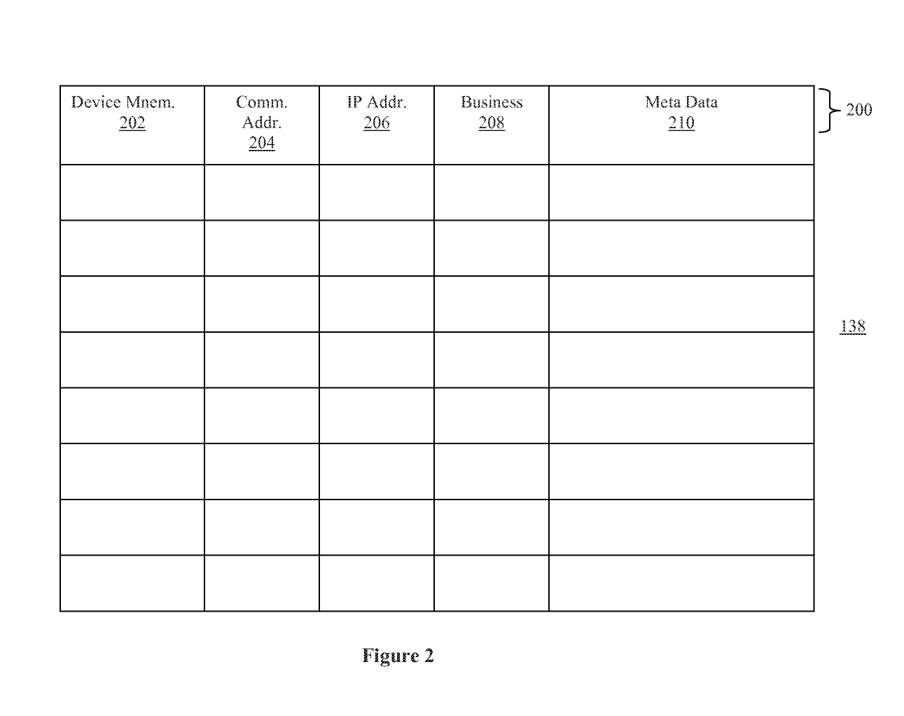

Referring now to FIG. 2, an example organization of device mnemonics and their associated data, in accordance with various embodiments, is shown. As illustrated, in embodiments, each device mnemonic record 200 may include the registered device mnemonic 202, its associated communication address 204, and metadata 210. Further, in some embodiments, the device mnemonic record 200 may include a business indication 208 of a business associated with the device mnemonic 202. Further, for embodiments where registration engine 132 further resolves the address to an IP address, record 200 may further include the IP address 206.

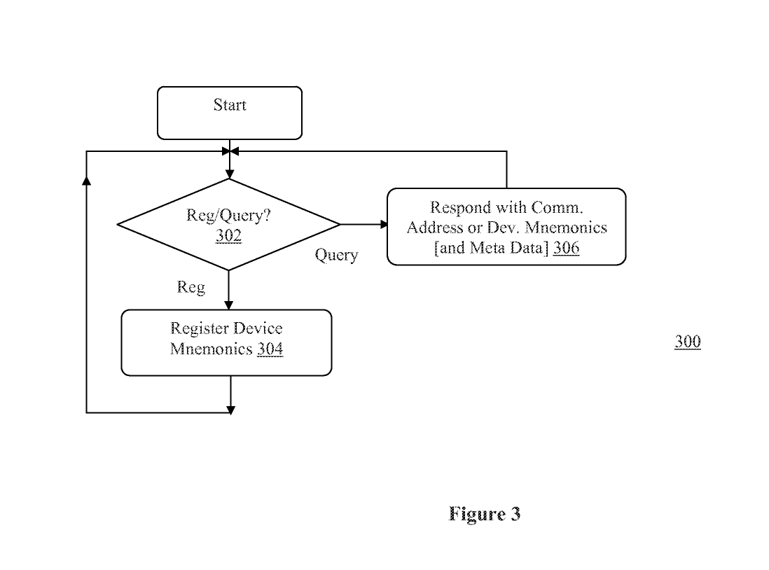

Referring now to FIG. 3, an example process for providing device mnemonics services, in accordance with various embodiments, is illustrated. As shown, process 300 may include operations at blocks 302-306. The operations may be performed, e.g., by the earlier described registration engine 132 and response engine 134 of device mnemonics server 102.

At block 302, a request for service may be received. In response, a determination may be made on whether the request is for registration of a device mnemonic, for retrieving communication addresses and/or metadata associated with a device mnemonic, or for retrieving a device mnemonic associated with a communication address, business, or other metadata. An example request to register a device mnemonic may be a request to register, e.g., “&Ravis_car” as a device mnemonic. An example request for data associated with a device mnemonic may comprise a query for the communication address and/or metadata associated with a device mnemonic. An example request for device mnemonics may comprise a query for device mnemonic for a business e.g., “Frank's Dry Cleaning”,” or a device mnemonics associated with a communication address, e.g., “ravi@example.com” or, e.g., “256.0.22.512”. Note that one or more device mnemonics, e.g., device mnemonics registered by different family members, or different users of a device, such as “&Ravis_car,” and “Asnani_car_{—}1,” may resolve to the same communication address.

On determining that the request is for registration of a device mnemonic, process 300 may proceed to block 304. At block 304, the device mnemonic being registered may be accepted and stored, e.g., in storage 116. In embodiments, registration engine 132 may be configured to ensure each registered device mnemonics is unique, and deny registrations for device mnemonics that have already been registered. In other embodiments, registration engine 132 may be configured to accept similar or identical device mnemonics for different devices when those devices may otherwise be differentiated. For example, if the devices are used in different geographic areas, it may be unlikely that the use of the same device mnemonic may be used for the two different devices. Similarly, if the identical device mnemonic for one or both devices is not intended to be shared outside of an identifiable group of persons, registration engine 132 may be configured to accept these similar or identical device mnemonics.

Additionally, acceptance and storage of the device mnemonics may include acceptance and storage of a communication address to be associated with the device mnemonics. For example, on accepting and storing the example device mnemonic of “&Ravis_car,” the example communication address “raviscar@example.com,” may be accepted and stored as the communication address to be associated with the example device mnemonic of “&Ravis_car.” The example device mnemonics are merely intended to be illustrative and is not to be read as limiting on the present disclosure. It is anticipated that a wide range of device mnemonics, including e.g., private device mnemonics, such as “&Ryan_bathroom_scale,” may be accepted and stored.

Further, in embodiments, concurrent with the initial registration or subsequent to the initial registration, acceptance and storage of the device mnemonic may further include acceptance and storage of metadata to be associated with the device mnemonics. For example, metadata may include indications of communication protocols which may be used with the car. In another example, metadata may include indications of instructions which may be recognized by the associated device. For example, for the example device mnemonic of “&Ravis_car,” metadata may include a device-control protocol that may be used for communication with the car associated with the device mnemonic, or instructions, such as, for example “start car” or “report milage,” that may be understood by the car. In other embodiments, metadata may include information regarding a physical location or business associated with the device. For example, if for the example device mnemonic of “&Als_home,” a device mnemonic associated with a home automation system, metadata may include the physical address of the home. In another example, for the example device mnemonic of “&Franks_dry_cleaning,” a device mnemonic associated with a customer-facing computer server for a dry cleaning establishment, the metadata may include information about the business itself, such as, e.g., business name, hours, services, prices, etc. The example metadata are merely intended to be illustrative and are not to be read as limiting on the present disclosure. It is anticipated that a wide range of metadata may be accepted and stored for each device mnemonics. Thereafter, process 300 may return to block 302, and continue therefrom as earlier described.

Back at block 302, if the result of the determination is a request for data associated to a device mnemonic or device mnemonics associated with a communication location, business, or other metadata, process 300 may proceed to block 306. At block 306, in response to a request for data associated to device mnemonics, the response may include one or more associated communication addresses. Additionally, if the request also requested metadata (or particular type of metadata), the response may further include some or all the metadata matching the request criteria. Thereafter, process 300 may return to block 302, and continue therefrom as earlier described.

Referring to FIG. 1 again, as described earlier, it is anticipated, in addition to client device 104, servers 106 of various online services may also utilize the device mnemonics services of device mnemonics server 102 to enhance the services they provide. For example, an online search may support search for device mnemonics and/or information related to device mnemonics, thereby enhancing the user experience for searching for information related to a device and/or business. On receipt of a search query, the search engine may determine whether the search query includes a device mnemonic or a request for device mnemonic at a location or within an area. On determination that the search query includes a device mnemonic or a request for device mnemonics associated with a communication location or a business, instead of treating these search criteria as keywords, the search engine may query device mnemonics server 102 for the information instead. Further, the search engine may provide search services, additionally based on information associated with device mnemonics obtained from device mnemonics server 102.

In another non-limiting example, the online service may be a social networking services configured to facilitate client devices 104 to socially network with each other. In embodiments, the social networking services may extend its support to include supports that allow device mnemonics as “users.” As a result, owner user of device mnemonics may post contents against the device mnemonics. Other users may elect to be associated with a device mnemonic (e.g., “friend” the device mnemonic). These users may then see the posted contents for the device mnemonic, such as from a business associated with the device mnemonic, and/or postings from a device configured to report information, and/or receive notification from the social networking service about new contents being posted for the device mnemonic. Further, the social networking service may provide social networking, additionally based on information associated with device mnemonics obtained from device mnemonics server 102.

In still another non-limiting example, the online service may be a messaging service configured to facilitate client devices 102 to message each other, including e.g., but not limited to, short messages. In embodiments, the messaging service may extend its support to include supports that allow for recognition of device mnemonics. In other words, the messaging service may recognize a term starting off with the special characters “#&,” and followed by any number alphanumeric or special characters, as a device mnemonic, and that the term differs from other tagged words. As a result, a device mnemonic may become a tagged keyword or topic, enabling messages related to the device mnemonics to be easily recovered. Further, the messaging service may facilitate messaging, additionally based on information associated with device mnemonic obtained from device mnemonics server 102. For example, the messaging service may support creation and sending of messages to a device or business based on entry of a device mnemonic as the recipient. In such embodiments, the response engine 134 of device mnemonics server 102 may act as a resolver, providing communication addresses in exchange for device mnemonics, and facilitating messaging without requiring knowledge of the communication addresses by message senders.

In still another non-limiting example, the online service may be an Internet portal service, an e-commerce service, or an email service configured to respectively provide Internet portal, e-commerce, or email service to client devices 102. In embodiments, the Internet portal, e-commerce, or email service may extend its support to include supports for inclusion of device mnemonics in the Internet portal, e-commerce, and email service provided. In other words, the Internet portal, e-commerce, or email service may recognize device mnemonics in its provision of Internet portal, e-commerce, or email service, and facilitate resolution of device mnemonics with device mnemonics server 102. Further, the Internet portal, e-commerce, and email service may provide Internet portal, e-commerce, and email services, additionally based on information associated with device mnemonics obtained from device mnemonics server 102.

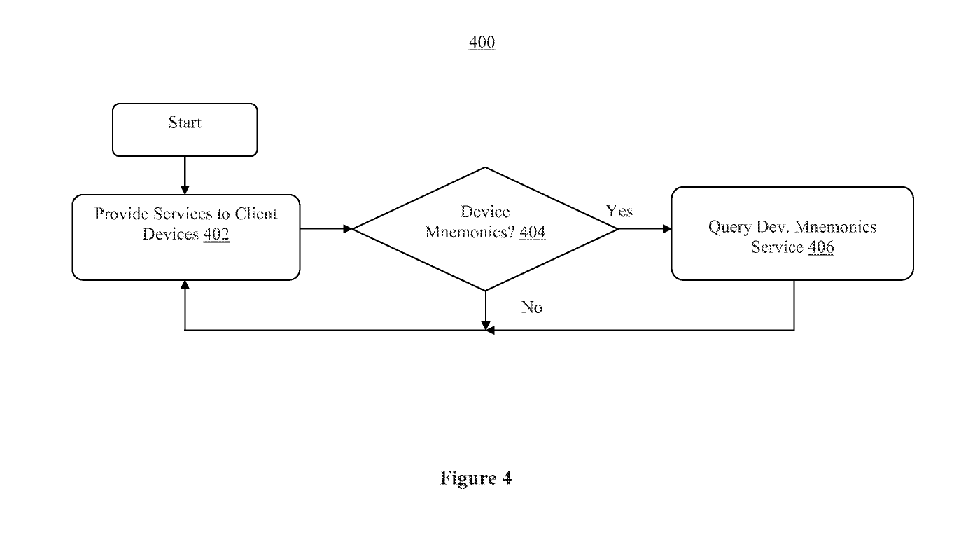

Referring now to FIG. 4, an example process for online services to utilize the device mnemonics service, in accordance with various embodiments, is illustrated. As shown, process 400 may include operations at blocks 402-406. The operations may be performed e.g., by application services 144 of FIG. 1 of various online services. As shown, process 400 may start at block 402. At block 402, an online service may provide its online services to its users. From block 402, process 400 may proceed to block 404. At block 404, a determination may be made on whether a service requested involves device mnemonics, and whether assistance from device mnemonics server 102 is needed. On determination that the service requested involves device mnemonics, and assistance from device mnemonics server 102 is needed, process 400 may proceed to block 406. At block 406, the online service may query device mnemonics server 102 for address and/or metadata of a device mnemonic, or for device mnemonics associated with a communication location or with a business.

From block 406, process 400 may return to block 402, and continue there from as earlier described, except the services may now be provided leveraging on the information obtained from device mnemonic server 102. For example, application service 144 (search, social networking, messaging etc.), through a device mnemonic associated with an business, e.g. Frank's Dry Cleaning, may be able to obtain information associated with the device mnemonic associated with Frank's Dry Cleaning, and provide its service leveraging on this information obtained from device mnemonics server 102. Similarly at block 404, on determination that the service requested does not involve device mnemonics or not need the assistance of device mnemonics server 102, process 400 may return to block 402, and continue there from as earlier described.

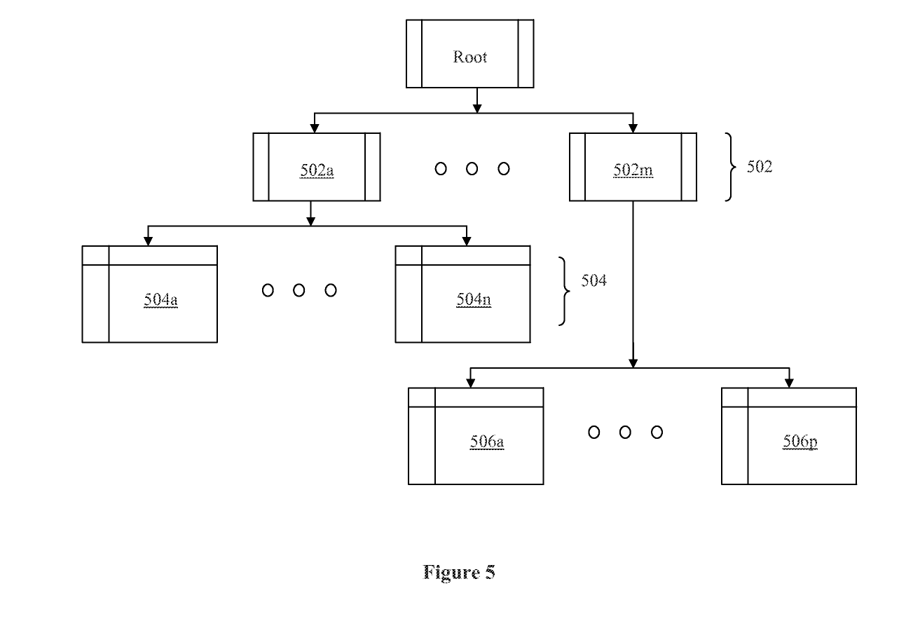

Referring now briefly back to FIG. 2, in embodiments, the device mnemonics and their associated data 138 may be stored in storage 120 in any one of a number of data organizations or structures, to facilitate efficient traversal for identification of potential relevant device mnemonics and their associated data 138, as well as to provide support for non-unique device mnemonics. FIG. 5 illustrates an example organization of the device mnemonics and their associated data 138, in accordance with various embodiments. Example organization 500 may be a hierarchical organization/structure having a number of organization levels, including one or more intermediate or node levels 502 and the lowest or leaf level 504 or 506. In embodiments, device mnemonics and their associated data may be stored in the lowest or leaf level 504 or 506, such as 504a . . . 504n or 506a . . . 506p. Further, one or more intermediate levels 502, 504, and so forth, may be used to differentiate different groupings of device mnemonics, such as by business, geographic area, user, etc.

For example, in one embodiment, a node 506a at a lowest level 506 may store the device mnemonic for “&Ryans_server” which is associated with a server in Portland, Oreg. This node may be stored under intermediate node 502m which is itself associated with Portland, Oreg. Another node, for example, 504a, may also be associated with a “&Ryans_server” that is located in Chicago, Ill., and the node may be stored below intermediate node 502a that is associated with Chicago, Ill. In another example, different intermediate nodes may be associated with different businesses. By using hierarchical storage models for storing device mnemonics, techniques described herein may facilitate the usage of non-unique device mnemonics.

The above example is not intended to be limiting on the present disclosure. The present disclosure may be practiced with any data organization or structure, depending on the application. In the case of hierarchical organization, the hierarchical organization may have any number of levels, with the nodes of the intermediate levels storing information defining any geographic, business, political, cultural, social, and/or economic organizations.

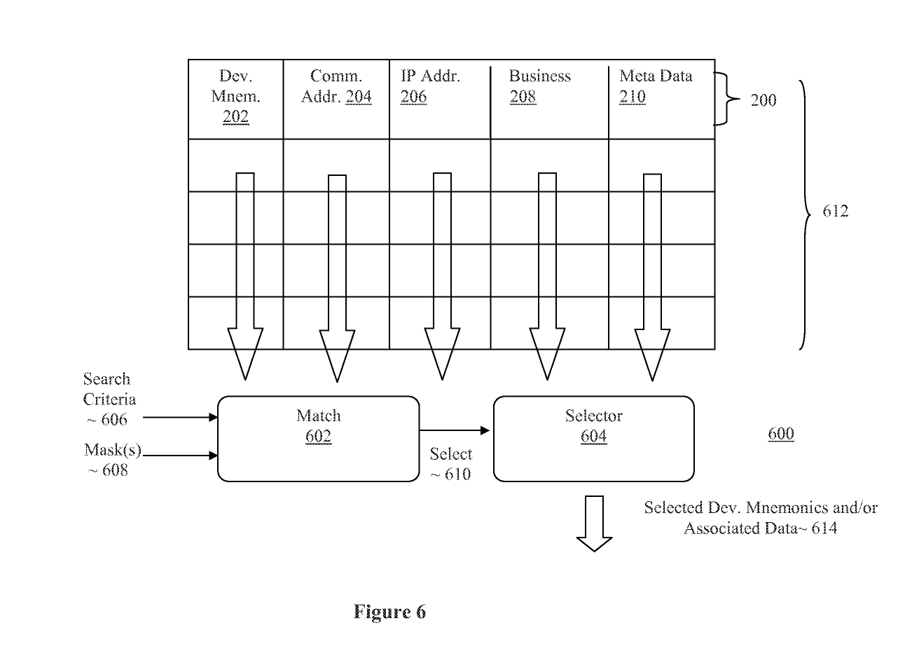

FIG. 6 illustrates an example storage and access of the device mnemonics and their associated data, in accordance with various embodiments. In applications/embodiments, or in a particular instance in time in the use of an application, one or more operational subsets of the device mnemonics and their associated data 138 may be cached by one or more client devices 104 or servers 102 and 106. For example, a portable or handheld client device 104 may be provided with the subset of device mnemonics and their associated data of one or more areas, regions, if the application or an instant use of the application is known to be confined in the one or more areas/regions or with a subset of businesses or persons. The example subset is not meant to be limiting, other subset derivations of the larger set of device mnemonics and associated data are also possible and anticipated.

For the example applications/embodiments, the subset of device mnemonics and their related may be stored in a content addressable memory (CAM) 600 on the particular client device 104 or one or servers 102/106. CAM 600, in addition to storage locations 612 for storing each 200 of the subset of device mnemonics and their associated data 138, may be configured with match circuitry 602 and selector 604, coupled with each other as shown. An application or service on access of CAM 600 may also provide device mnemonics or communication addresses based search criteria 606, optionally accompanied with one or more masks 608.

On access, storage locations may output device mnemonics and/or their communication addresses to match circuitry 602 and the associated data to selector 604. In embodiments, device mnemonics may be provided to match circuitry 602 and/or selector 604 depending on application (e.g., with the additional employment of a switch (not shown). Match circuitry 602 may output one or more select signals 610 to selector 604, based on communication addresses 204 (possibly including IP addresses 206), search criteria 606, and mask(s) 608 (if provided). Selector 604 may then select and output device mnemonics 202, communication addresses 204 and/or metadata 210, based on select signal(s) 610. Accordingly, the ability to select associated device mnemonics and associated data may be provided.

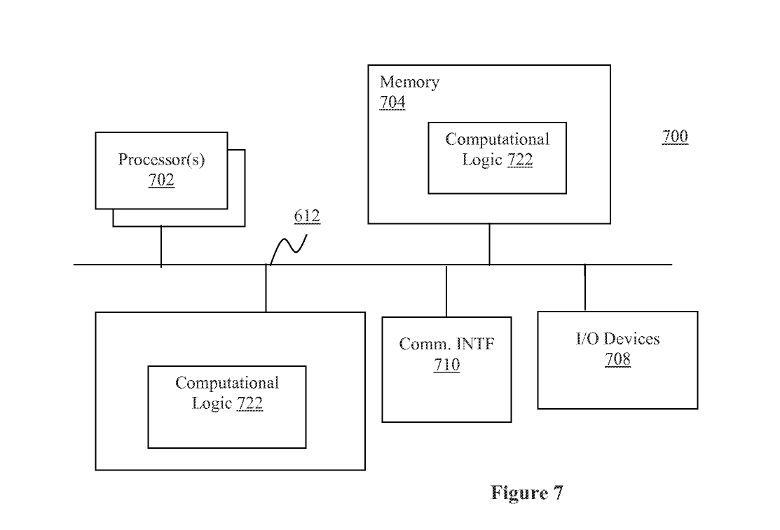

Referring now to FIG. 7, wherein an example computer suitable for use as either client device 104 or server 102/106 of FIG. 1, in accordance with various embodiments, is illustrated. As shown, computer 700 may include one or more processors or processor cores 702, and system memory 704. For the purpose of this application, including the claims, the terms “processor” and “processor cores” may be considered synonymous, unless the context clearly requires otherwise. System memory 704 may include volatile and or non-volatile memory, including CAM. Additionally, computer 700 may include mass storage devices 706 (such as diskette, hard drive, compact disc read only memory (CD-ROM) and so forth), input/output devices 708 (such as display, keyboard, cursor control and so forth) and communication interfaces 710 (such as network interface cards, modems and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the various operations earlier described, e.g., the operations associated with registration engine 132, response engine 134, an/or application services 144 collectively denoted as computational logic 722. Computational logic 722 may be implemented with assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of computational logic 722 may be employed to distribute computational logic 722 and program various computing devices.

The number, capability and/or capacity of these elements 710-712 may vary, depending on whether computer 700 is used as a client device 104 or server 102/106. When use as client device 104, whether client device 104 is a stationary or mobile device, like a smartphone, in-vehicle/portable navigation/infotainment systems, computing tablet, ultrabook or laptop, with general or specific applications. The constitutions of these elements are otherwise known, and accordingly will not be further described.

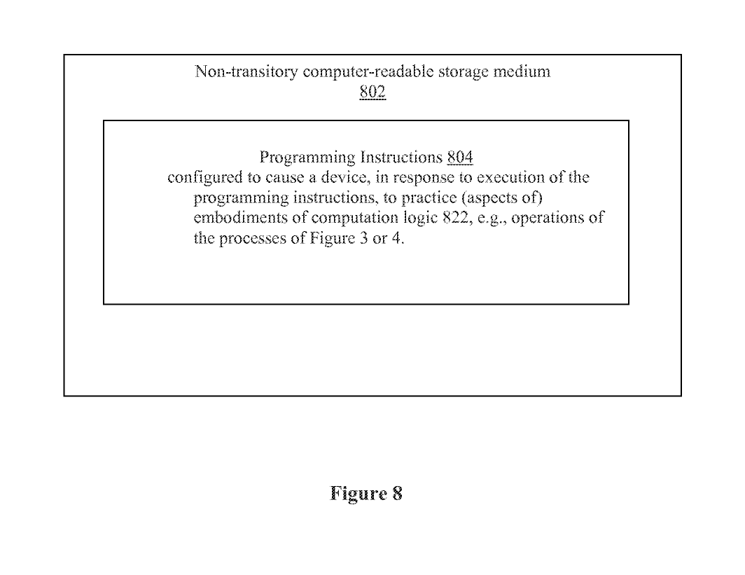

FIG. 8 illustrates an example non-transitory computer-readable storage medium having instructions configured to practice all or selected ones of the operations associated with registration engine 132, response engine 134, an/or application services 144, earlier described; in accordance with various embodiments. As illustrated, non-transitory computer-readable storage medium 802 may include a number of programming instructions 804. Programming instructions 804 may be configured to enable a device, e.g., computer 400, in response to execution of the programming instructions, to perform various ones of the earlier described operations, e.g., various operations of process 300 of FIG. 3 or process 400 of FIG. 4. In alternate embodiments, programming instructions 804 may be disposed on multiple non-transitory computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for facilitating communication with a device, comprising:
one or more processors;
one or more storage devices coupled with the one or more processors;
one or more communication interfaces coupled with the one or more processors;
a registration module to be operated by the one or more processors to accept a registration of a device mnemonic associated with a device, via the one or more communication interfaces, and store the device mnemonic in the one or more storage devices, wherein acceptance of registration and storage of the device mnemonic further comprises receipt of a communication address of the device, the communication address to be associated with the device mnemonic, and storage of the communication address as associated with the device mnemonic; and
a response module to be operated by the one or more processors to respond to a query about the device mnemonic with at least the associated communication address.

2. The apparatus of claim 1, wherein the device mnemonic comprises a special character followed by a plurality of alphanumeric or special characters.

3. The apparatus of claim 1, wherein:
acceptance of registration and storage of the device mnemonic further comprises receipt of metadata to be associated with the device mnemonic, and storage of the metadata associated with the device mnemonic; and
the response module is further to selectively respond to the query about the device mnemonic with some or all of the metadata.

4. The apparatus of claim 3, wherein the metadata comprises an identification of a business associated with the device.

5. The apparatus of claim 3, wherein the metadata comprises a description of one or more communication protocols for use with the device.

6. The apparatus of claim 3, wherein the metadata comprises a description of one or more instructions which may be recognized by the device.

7. The apparatus of claim 1, wherein the registration module is further to resolve the communication address to an Internet Protocol (“IP”) address for the device, and store the IP address as a further communication address associated with the device mnemonic.

8. The apparatus of claim 7, wherein the response module is further to be operated to respond to the query about the device mnemonic with the IP address for the device.

9. The apparatus of claim 1, wherein:
the query about the device mnemonic is received from a client device, via the one or more communication interfaces;
the client device comprises a browser; and
the response module is further to support interaction with the response module through the browser.

10. The apparatus of claim 1, wherein:
the query about the device mnemonic is received from a selected one of a search engine, a social network, or a messaging service;
the search engine is further to allow searches for device mnemonics or information associated with device mnemonics;
the social network includes supports for the device mnemonics as users, and supports for other users to be associated with or interact with the device mnemonics
the messaging service includes support for device mnemonics, and support for performing message searches based on device mnemonics; and
the response module is further to support interaction with the search engine or the messaging service.

11. At least one computer-readable non-transitory storage medium comprising a plurality of instructions to cause a computer system, in response to execution of the instructions by the computer system, to respond to a query about a registered device mnemonic, wherein the response includes a communication address or metadata associated with the registered device mnemonic.

12. The storage medium of claim 11, wherein the device mnemonic comprises a special character followed by a plurality of alphanumeric or special characters.

13. The storage medium of claim 11, wherein the computer system is further caused to accept a registration of the device mnemonic, and store the device mnemonic in one or more storage devices, wherein acceptance of registration and storage of the device mnemonic further comprises receipt of the address to be associated with the device mnemonic, and storage of the communication address as associated with the device mnemonic.

14. The storage medium of claim 13, wherein:
acceptance of registration and storage of the device mnemonic further comprises receipt of metadata to be associated with the device mnemonic, and storage of the metadata associated with the device mnemonic; and
the computer system is further caused to selectively respond to the query about the device mnemonic with some or all of the metadata.

15. The storage medium of claim 11, wherein:
the communication address is resolved to an Internet Protocol (“IP”) address, and
the IP address is stored as further metadata associated with the device mnemonic.

16. The storage medium of claim 11, wherein:
the query about the device mnemonic is received from a client device, via one or more communication interfaces of the computer system
the client device comprises a browser; and
the computer system is further caused to support interaction with the browser.

17. The storage medium of claim 11, wherein:
the query about the device mnemonic is received from a selected one of a search engine, a social network or a messaging service;
the search engine is further to allow searches for device mnemonic or information associated with device mnemonics;
the social network includes supports for device mnemonics as users, and supports for other users to be associated with or interact with the device mnemonic;
the messaging service include support for device mnemonics, and support for performing message searches based on device mnemonics; and
the computer system is further caused to support interaction with the search engine, the social network or the messaging service.

18. An computer-implemented method for providing information about a device, comprising:
accepting, by a computing system, a registration of a device mnemonic associated with a device;
storing, by the computing system, the device mnemonic in one or more storage devices of the computing system, wherein acceptance of registration and storage of the device mnemonic further comprises receiving a communication address of the device, the communication address to be associated with the device mnemonic, and storing the communication address as associated with the device mnemonic; and
responding, by the computing system, to a query about the device mnemonic with at least the associated communication address.

19. The method of claim 18, wherein:
accepting registration and storing the device mnemonic further comprises receiving metadata to be associated with the device mnemonic, and storing the metadata as associated with the device mnemonic; and
responding further comprises selectively responding to the query about the device mnemonic with some or all of the metadata.

20. An apparatus for providing information about devices, comprising:
one or more processors;
one or more storage devices coupled with the one or more processors; and
a search engine to be operated by the one or more processors to provide search services to a plurality of client devices, wherein the search services include searches for information associated with device mnemonics; and
wherein the search engine is further to query a device mnemonics service for the information associated with device mnemonics, in response to receipt of a search for information associated with device mnemonics or a search for device mnemonics, wherein a device mnemonic has associated information.

21. The apparatus of claim 20, wherein the search engine is further to provide search services, additionally based on response to the query from the device mnemonics service metadata.

22. An apparatus for providing information about devices, comprising:
one or more processors;
one or more storage devices coupled with the one or more processors;
a social networking service to be operated by the one or more processors to provide social networking to a plurality of client devices, wherein:
the social networking service includes supports for device mnemonic as users, and supports for other users to be associated with or interact with device mnemonics; and
the social networking service is further to query a device mnemonics service for a communication address based on a device mnemonic; and
a device mnemonic has at least an associated address.

23. The apparatus of claim 22, wherein the social networking service is further to provide social networking, additionally based on response to the query from the device mnemonics service.

24. An apparatus for providing information about devices, comprising:
one or more processors;
one or more storage devices coupled with the one or more processors;
a messaging service to be operated by the one or more processors to facilitate messaging by a plurality of client devices, wherein:
the messaging service includes recognition of device mnemonics; and
the messaging service is further to query a device mnemonics service for information associated with a device mnemonic; and
a device mnemonics has associated information.

25. The apparatus of claim 24, wherein the messaging service is further to facilitate messaging, additionally based on response to the query from the device mnemonics service.

26. An apparatus for providing information about devices, comprising:
one or more processors;
one or more storage devices coupled with the one or more processors;
an Internet portal service, an e-commerce service, or an email service respectively to be operated by the one or more processors to provide Internet portal service, e-commerce service, or email service to a plurality of client devices, wherein the Internet portal service, e-commerce service, or email service includes support of device mnemonics; and
wherein the Internet portal service, e-commerce service, or email service is further to query a device mnemonics service, for information associated with a device mnemonic;
wherein a device mnemonic has associated information.

27. The apparatus of claim 26, wherein the Internet portal service, an e-commerce service, or an email service is further to provide the corresponding Internet portal service, e-commerce service, or email service additionally based on response to the query from the device mnemonics service.

28. A computer-implemented method for providing information about a device, comprising:
registering with a device mnemonics service, using a computing system, a device mnemonic, including registering an address to be associated with the device mnemonic.

29. The method of claim 28, further comprising registering, by the computing system, meta data to be associated with the device mnemonic.
